(19) United States
(12) Patent Application Publication
(10) Pub. No.: US 2003/0063196 A1
(43) Pub. Date: Apr. 3, 2003

(54) Handheld portable interactive data storage device

(76) Inventors: Dennis Palatov, Portland, OR (US); Steve E. Recek, Mission Viejo, CA (US); Michael Bajc, Mission Viejo, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/566,436

(22) Filed: May 8, 2000

(51) Int. Cl. G06F 15/16

(52) U.S. Cl. 348/211.2

(57) ABSTRACT

A portable interactive data storage device includes a disk drive, a microprocessor, a USB port, and a data storage card slot. The device also includes a small liquid crystal matrix display and a small number of user controls. The device is configured for data storage, rather than as a small general purpose computer, and preferably does not include a keyboard. The data storage card slot is configured to accept small data storage cards, such as flash memory PC cards or CompactFlash cards through a PC card adapter. The disk drive has a substantially larger capacity than the data storage cards. A user loads data onto a data storage card using a portable electronic device, such as a digital camera. The user then inserts the card into the storage device and uploads the data to the disk drive. The card can then be repeatedly reused in the digital camera by uploading the data to the storage device after each use. Eventually, the user returns to a computer and connects the storage device to the computer through the USB port and uploads the accumulated data to the computer. The device can also be used to store data downloaded from a computer, such as digital audio in MP3 form. The data can then be incrementally transferred to a data storage card and used on a portable electronic device, such as an MP3 player.

### BACKGROUND OF THE INVENTION

1. Field of the Invention

This invention relates generally to portable data storage devices and, more particularly, the invention relates to a portable data storage device that supports basic interactive functionality through a processor running an operating system.

2. Description of the Related Art

Presently available small form factor (small size) data storage cards are configured to be used primarily with portable electronic devices, such as digital cameras, laptop computers, and personal digital assistants. Several types of small form factor memory cards are presently available such as PC (PCMCIA) Type I, II, and III cards, CompactFlash (CF) cards, CompactFlash Type II (CF2) cards, SmartMedia cards, and Sony's Memory Stick cards. These memory cards typically have capacities of 8 megabytes to upwards of 200 megabytes and are typically implemented using flash memory technology. Cards that contain miniature disk drives are also presently available, such as IBM's Microdrive, which holds 340 megabytes and has a CompactFlash Type II form factor.

Digital cameras, in particular, create substantial amounts of data. A high quality compressed digital photograph can easily be 1 megabyte or more in size. Therefore, an 8 megabyte card may only hold about 8 compressed images. Uncompressed images can easily be 10 to 20 megabytes in size. Once a card is full, the data must be uploaded to a personal computer in order to use the card again. A photographer who takes many high-quality pictures between opportunities to upload his data may have to purchase several hundreds or thousands of megabytes of memory. Data storage cards, however, have a price of at least $1 per megabyte or more. A solution is needed that allows a photographer to economically take more, and preferably a practically unlimited number of digital photos, without the need to frequently upload data to a desktop computer.

### SUMMARY OF THE INVENTION

In a preferred embodiment, a portable interactive data storage device includes a disk drive, a microprocessor, a USB port, and a data storage card slot. The device also includes a small liquid crystal matrix display and a small number of user controls. The device is configured for data storage, rather than as a small general purpose computer, and preferably does not include a keyboard. The data storage card slot is configured to accept small data storage cards, such as flash memory PC cards or CompactFlash cards through a PC card adapter. The disk drive has a substantially larger capacity than the data storage cards.

In a preferred process, a user loads data onto a data storage card using a portable electronic device, such as a digital camera. The user then inserts the card into the storage device and uploads the data to the disk drive. The card is then repeatedly reused in the digital camera by uploading the data to the storage device after each use. Eventually, the user returns to a computer and connects the storage device to the computer through the USB port and uploads the accumulated data to the computer.

In another process, the device is used to store data downloaded from a computer, such as digital audio in MP3 form. The data is then incrementally transferred to a data storage card and used on a portable electronic device, such as an MP3 player.

### BRIEF DESCRIPTION OF THE DRAWINGS

The present invention will be described below in connection with the attached drawings in which:

FIG. 1A illustrates a preferred embodiment of a handheld portable interactive data storage device;

FIG. 1B illustrates the use of the data storage device in conjunction with a portable electronic device;

FIG. 1C illustrates the data storage device connected to a connection box, which allows the data storage device to be connected to a computer and/or a charging device;

FIG. 1D illustrates the storage device and the connection box connected to a computer through a communication cable;

FIG. 1E illustrates the device inserted in a device dock, an alternative to the connection box configured to hold the device in a near vertical position;

FIG. 2A illustrates the main functional components of a preferred embodiment of the storage device;

FIG. 2B illustrates some additional functional components of the preferred embodiment of the storage device;

FIGS. 3A-E illustrate various configurations in which data can be transferred to and from the handheld portable interactive data storage device;

FIG. 4A illustrates a first process in which a user to reuses a data storage card to repeatedly capture newly created data without having to upload captured data to a computer between uses; and

FIG. 4B illustrates a second process for using the handheld portable electronic storage device as a repository of data to be used in a portable electronic device.

### DETAILED DESCRIPTION OF THE EMBODIMENTS

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present invention. The present invention, however, may be practiced without the specific details or with certain alternative equivalent components and methods to those described herein. In other instances, well-known methods and components have not been described in detail so as not to unnecessarily obscure aspects of the present invention.

I. Device Overview

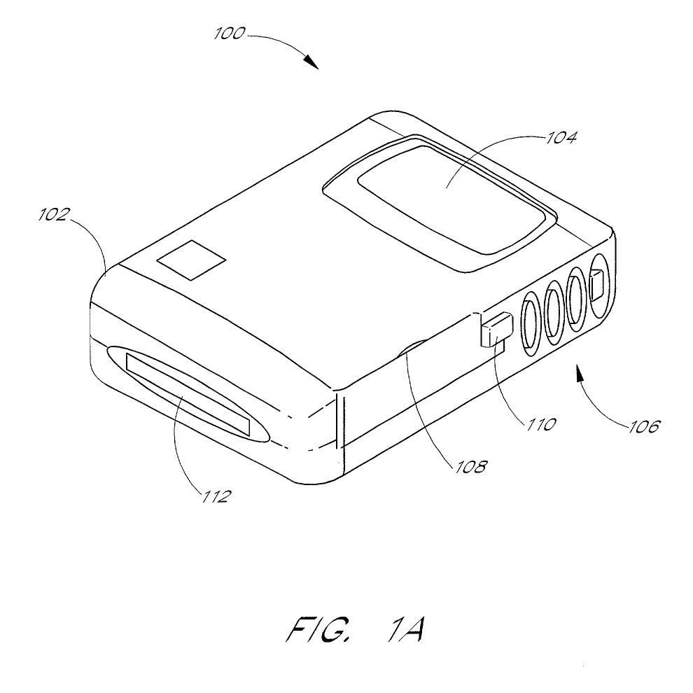

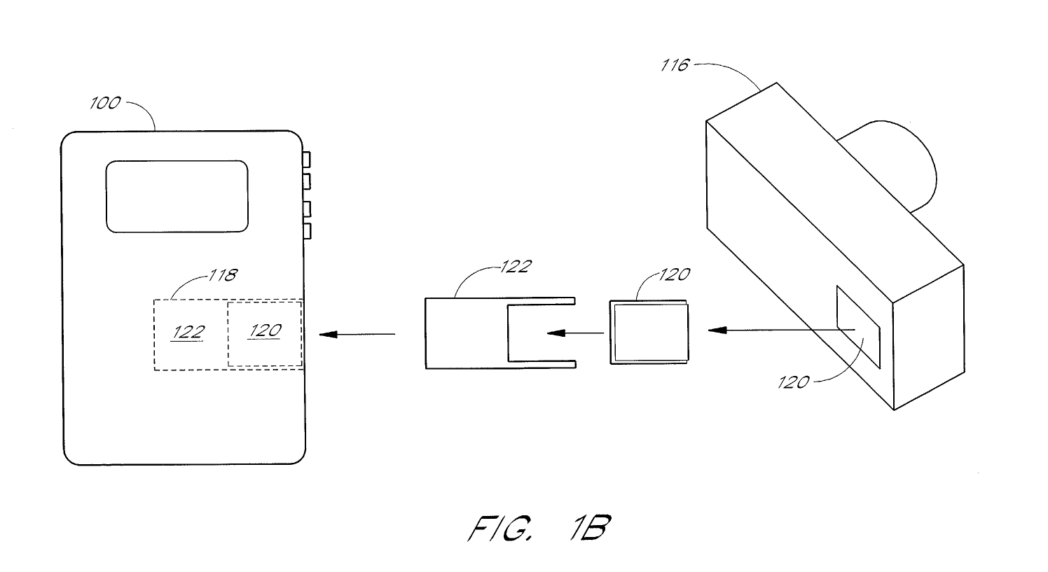

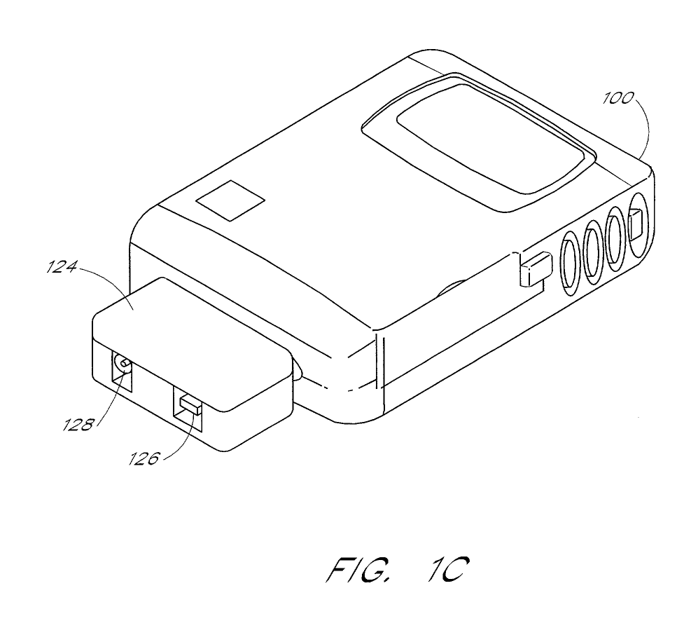

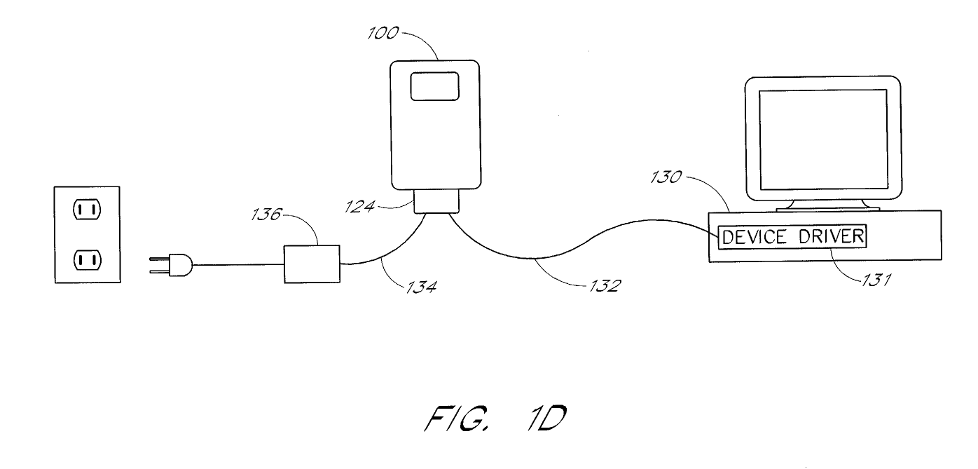

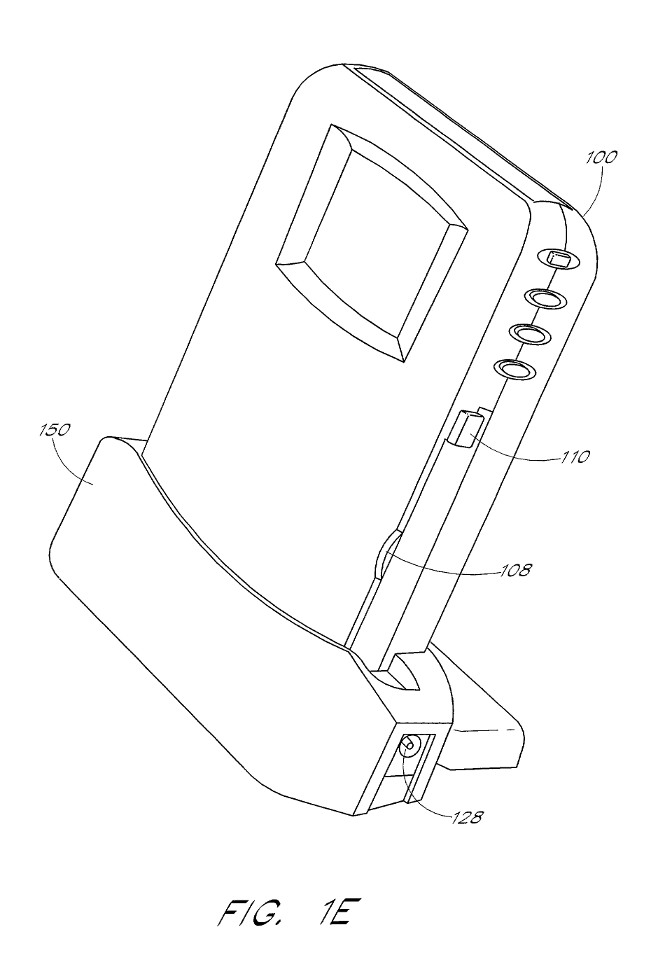

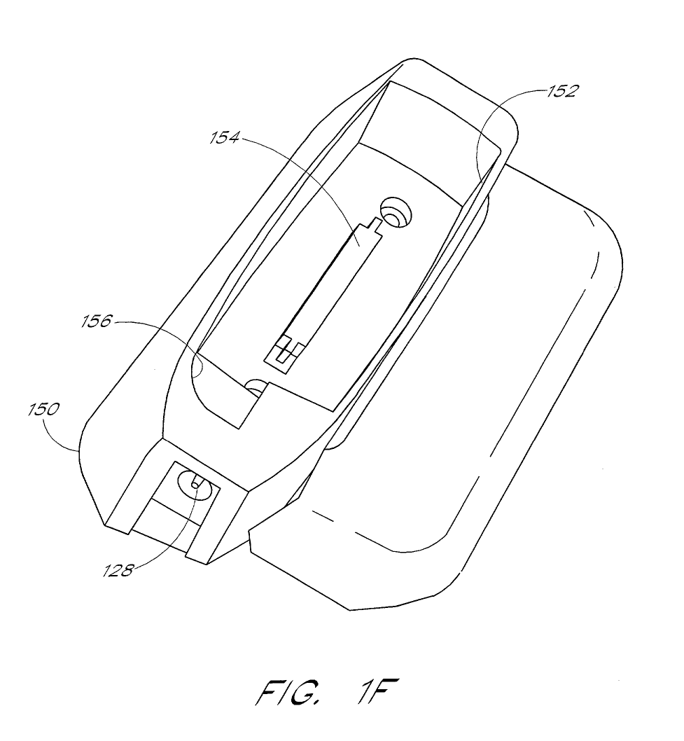

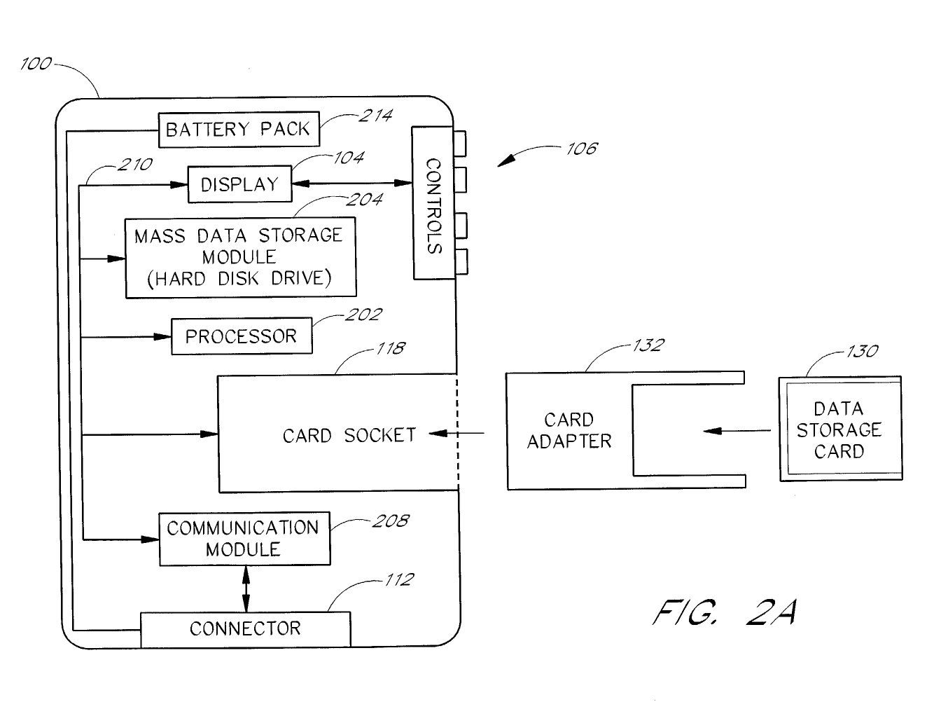

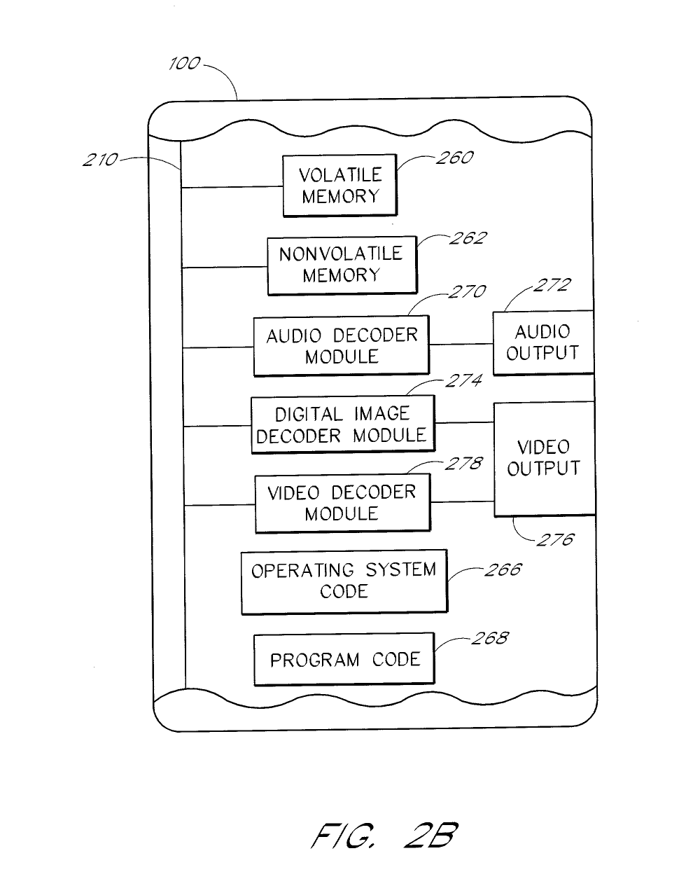

FIG. 1A illustrates a preferred embodiment of a handheld portable interactive data storage device 100. In the preferred embodiment, the device 100 has its own processor 202 (FIG. 2A), hard disk drive 204 (FIG. 2A), and operating system code 266 (FIG. 2B). A user interacts with the device 100 through a display 104 and a small number of user controls 106. The user controls 106 preferably include a power button, up and down buttons, and a select button.

The data storage device 100 is preferably configured for data storage, rather than as a portable computer. Accordingly, the storage device 100 preferably does not include a keyboard. A keyboard typically includes a full set of alphanumeric keys that allow a user to quickly enter letters and numbers. By not including a keyboard, the device 100 can be made smaller and less expensive.

The device 100 has a palm-sized housing 102 configured to allow the device 100 to be easily held with one hand while being operated with the other hand. The housing 102 contains the processor 202, the disk drive 204, and other internal components that will be discussed in detail in Section II below. In the preferred embodiment, the dimensions of the housing 102 are approximately 14 cm by 9 cm by 2 cm.

FIG. 1B illustrates the use of the data storage device 100 in conjunction with a portable electronic device 116, such as a digital camera. A data storage card 120 is inserted in the portable electronic device 116 and loaded with data. The data storage card 120 is then inserted into the device's data storage card socket 118, using an adapter 122 if necessary. The storage device 100 then uploads the data from the data storage card 120 onto the storage device's disk drive 204. The data storage card 120 can then be reinserted into the portable electronic device 116 and reloaded with data. The capacity of the disk drive 204 is preferably substantially larger than the capacity of the data storage card 120 and, therefore, several transfers of data can be performed.

The storage device 100 is preferably also configured to be able to transfer data from the disk drive 204 onto the data storage card 120. Accordingly, data downloaded from the storage device onto a data storage card 120 can be used in a portable electronic device 116, such as an MP3 digital audio player.

The data storage card socket 118 is preferably a PC card socket. As illustrated in FIG. 1A, the socket 118 is protected by a door 108, which is operated by an eject button 110. The data storage card 120 may be a CompactFlash card, a SmartMedia card, a Sony Memory Stick, or any storage device that can be adapted to fit into a PC card adapter 122. The adapter 122 is preferably a PC card adapter that adapts the data storage card 120 for use in the card socket 118. The data storage card 120 may also be in the form of a PC card, in which case no adapter 122 is necessary.

As illustrated in FIG. 1C, the data storage device 100 can be connected to a connection box 124 through a connector 112 (FIG. 1A). The connection box 124 allows the device 100 to be connected to a computer and/or a charging device. The connection box 124 provides a communication port 126, which is preferably a universal serial bus (USB) port, through which the device 100 can be connected to a computer. The connection box 124 also provides a receptacle 128 through which power is supplied.

In the preferred embodiment, the physical characteristics of the connector 112 and the connection box 124 (but not necessarily the communication protocol used) conform to the industry standard Device Bay specification (see www.device-bay.org). The Device Bay physical connector is advantageous due to its ruggedness, durability, and high connection density. Other types of connectors, however, may be used in the alternative. Power and communication channels may also be provided through separate connectors.

In the preferred embodiment, the connector 112 provides several types of connections through its contacts. A USB port allows the device 100 to be connected to a personal computer or other USB compatible device. The storage device can also supply power to another device, such as an MP3 player, through ground, 3.3 volt, and 5 volt contacts. Three additional serial ports, including an RS232 port, a high speed synchronous port, and an I²C port, provide communication channels to the device 100. The connections provided through the connector 112 can be accessed by providing an appropriate type of connection box 124 or cable. A connection cable can be fabricated, for example, to interface the storage device 100 to an MP3 player. The MP3 player, for example, may be powered by the ground and 3.3 volt power connections, may receive data to be decoded through the synchronous serial port, and may receive control information through the I²C port.

In the preferred embodiment, the connection box 124 provides a physical rerouting of the signals passed through the connector 112 to the communication port 126. The connection box 124 also provides a pathway to the connector 112 for power supplied through the receptacle 128. In alternative embodiments, active components can be included in the connection box 124. Components that would otherwise be included within the device 100 can be instead included in the connection box 124.

FIG. 1D illustrates the storage device 100 and the connection box 124 connected to a computer (PC) 130 through a communication cable 132. The cable 132 is preferably a USB cable that connects a USB port on the computer to the USB communication port 126 on the connection box 124. The computer 130 and the storage device 100 preferably communicate through the cable 132 using the USB 1.5 megabyte per second standard protocol. In alternative embodiments, the connection and protocol may be implemented using USB2, which is a higher speed version of USB, IEEE-1394 “firewire,” or a high-speed parallel port.

The computer 130 preferably executes a device driver 131 that supports communication with the storage device 100. The driver 131 and the device 100 are preferably configured to allow the disk drive 204 of the device 100 to be accessed as a first additional logical drive from the computer 130. The driver 131 and the device 100 are preferably also configured to allow the data storage card 120, if inserted in the card socket 118, to be accessed as a second additional logical drive from the computer 130. Accordingly, data can be transferred from disk drive 204 or the storage card 120 onto the computer 130, as well as from the computer 130 onto the disk drive 204 or the storage card 120.

A power cord 134, which supplies power from an AC adapter power supply 136, can also be attached to the device 100 through the power receptacle 128 on the connection box 124. The power supply 136 supplies power in order to recharge a rechargeable battery pack 214 (FIG. 2A) that preferably powers the device 100.

FIG. 1E illustrates the device 100 inserted in a device dock 150. The dock 150 is an alternative to the connection box 124 configured to hold the device 100 in a near vertical position. The dock 150 is otherwise preferably similar in function to the connection box 124. The dock 150 preferably includes a communication port (not illustrated) and a receptacle 128, similar to the receptacle 128 of the connection box 124 (FIG. 1C).

The device dock 150 is illustrated separately in FIG. 1F. The device dock 116 has a receiving socket 152 in which the device 100 is received. The receiving socket 152 has a receiving connector 154 configured to mate with the corresponding connector 112 on the storage device 100. The socket 152 preferably also has a cut out 156 that allows the door 108 to the data storage card socket 118 to be opened while the device 100 is docked.

II. Device Components

FIG. 2A illustrates the main functional components of a preferred embodiment of the storage device 100. In the preferred embodiment, the device 100 includes a processor 202, a mass data storage module 204, a data storage card socket 118, a display 104, and a communication module 208, all of which communicate through a bus 210.

FIG. 2B illustrates some additional functional components of the preferred embodiment of the storage device 100. The device 100 preferably also includes volatile memory 260 and nonvolatile memory 262, which are also connected to the bus 210. The volatile memory 260 is preferably implemented using dynamic random access memory, and the nonvolatile memory 262 is preferably implemented using flash memory. The processor 202 preferably uses the volatile memory 260 as working data storage space.

The processor 202 controls the various components of the storage device 100. In the preferred embodiment, the processor 202 is a Motorola Coldfire microprocessor. The processor 202 executes operating system code 266 (FIG. 2B) that provides a basic platform for operating the device 100. The operating system code 266 preferably also supports some basic applications in the form of program code 268. The operating system code 266 and the program code 268 are preferably stored in the nonvolatile memory 260, but may be stored on the mass data storage module 204. The code 266 and 268 can preferably be updated by loading new code into the nonvolatile memory 260 or onto the mass data storage module 204. The program code 268, like the operating system code 266, can be stored in the nonvolatile memory 262 or on the mass data storage module 204.

The mass data storage module 204 is a mass storage unit capable of permanently storing data and retaining the stored data without a supply of power. The module 204 preferably has at least a 1-gigabyte capacity, and more preferably has at least a 3-gigabyte capacity. In the preferred embodiment, the mass data storage module 204 is a 2.5 inch fixed hard disk drive of the type used in many laptop computers. In one embodiment, the mass data storage module 204 is a Toshiba MK-3212MAP (HDD2133) hard disk drive. The 2.5-inch Toshiba drive has a 3.5-gigabyte capacity, is 8.5 mm high, has a 13-ms average seek time, has an ATA-4 interface, and has a 33.3-megabyte/second Ultra DMA Mode 2 transfer rate.

In alternative embodiments, other forms of mass data storage may be used, such as, for example, an optical disk. The mass data storage module 204 can be implemented as a writable DVD drive. The DVD drive can be used to write a removable optical disk, which can then be placed in a computer's DVD drive. In still other embodiments, the mass data storage module 204 may be implemented using solid state technologies such as Flash memory or battery-backed DRAM.

The data storage card socket 118 receives the data storage card 120, possibly through the adapter 122. In the preferred embodiment, the data storage card socket 118 is a Type II PC card socket, configured to receive any Type I or Type II PC card device, such as a flash memory PC card or a CompactFlash memory card, using an adapter. Although the socket 118 may be capable of receiving any PC card, the storage device 100 is preferably configured to communicate only with data storage type devices, such as flash memory or miniature hard disk drives. The storage device 100 preferably does not support PC card modems, network cards or other non-storage type devices. As will be recognized by one skilled in the art, the data storage card socket 118 can also be configured to receive CompactFlash and other types of data storage cards without an adapter.

In the preferred embodiment, the processor 202 receives user input from the user controls 106. The user controls 106 preferably include a power button, up and down buttons, and a select button.

The display 104 is preferably a small liquid crystal matrix display. In the preferred embodiment, the display is a Samsung LCD with a 128×64 display format. In an alternative embodiment, the display 104 is a touch-sensitive display. In this case, user input can be received through the display 104, and the user controls 106 may be limited to a power button.

In the preferred embodiment, the operating system 266 and/or the program code 268 cause the processor 202 to display menus on the display 104. A user navigates the menus using the up and down buttons and selects options with the select button. The operating system 266 and/or the program code 268 are configured to allow the user to perform file operations such as copy, delete, and move. The file operations can preferably be performed on the mass data storage module 204, the data storage card 120, and between (e.g., copying files between) the mass data storage module 204 and the data storage card 120. More general operations, such as uploading all of the data from a data storage card 120 to the mass data storage module 204 are preferably also supported.

The communication module 208 supports communication with a computer 130 or other devices, preferably through the connection box 124 or the dock 150. The communication module 201 is preferably a USB controller that supports the USB standard communication protocol. The communication module is preferably connected to the connector 112.

A battery pack 214 is preferably also connected to the connector 112. The battery pack 214 preferably includes rechargeable NiMH batteries. The connector 112, the connection box 124, the power cord 134, and the power supply 136 preferably supply power to the connection box 112. The charging of the battery pack 214 may be regulated by a charge regulator (not illustrated).

In alternative embodiments, the storage device 100 can be configured to have some basic multimedia functionality. An audio decoder module 270 can be included to play audio files, such as MP3 music files. The audio decoder module 270 is preferably connected to an audio output 272, such as a headphone jack. A digital image decoder module 274 can be included to render digital images, such as bitmap, JPEG, or GIF images. The output of the image decoder module 274 can be directed to a video output 276 for communication to a video display. Alternatively, the output of the image decoder module 274 can be presented on the display 104 of the storage device 100, if the display 104 has a sufficient resolution. A video decoder module 278 can be included to render digital video, such as MPEG files. The output of the video decoder module 278 can be directed to the video output 276, or alternatively, can be rendered on the display 104. In one embodiment, the functionality of the audio decoder module 270, the digital image decoder module 274, and the video decoder module 278 can be incorporated into the program code 268 and executed by the processor 202.

III. Data Transfer Configurations

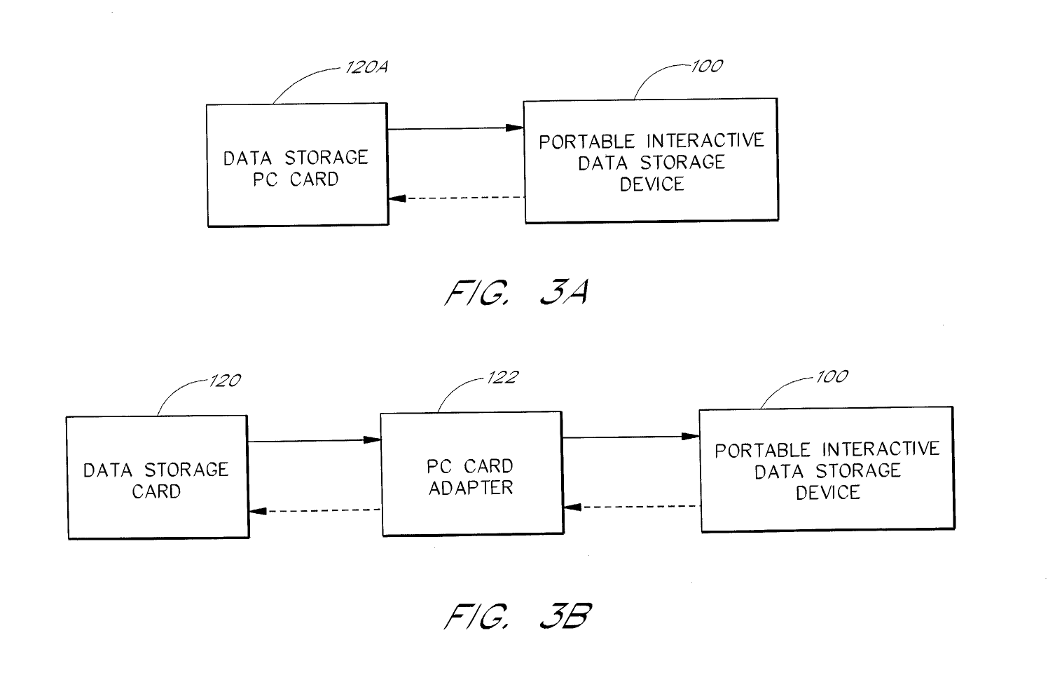

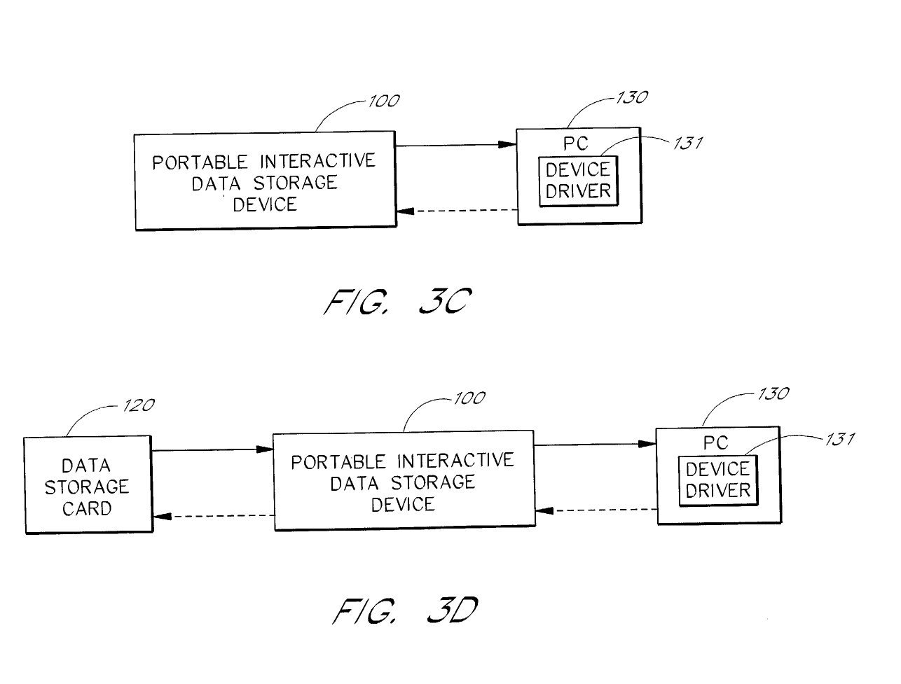

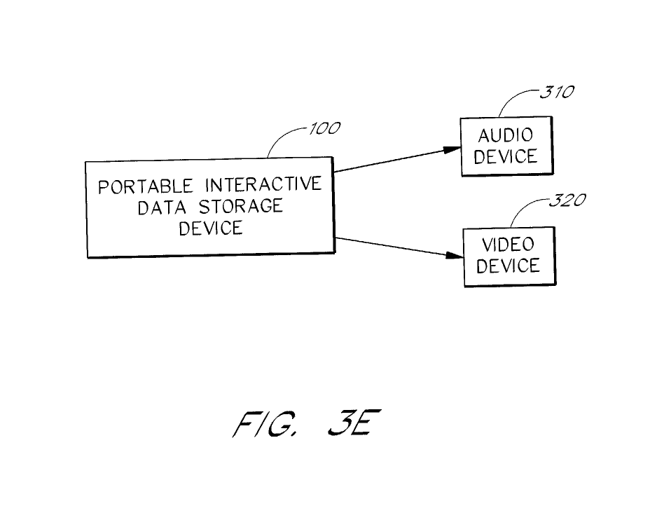

FIGS. 3A-E illustrate various configurations in which data can be transferred to and from the handheld portable interactive data storage device 100. In FIGS. 3A-B, the device 100 is not connected to a computer and the transfer of data is controlled by the user through the user controls 106 and the menus displayed by the processor 202 on the display 104. In FIGS. 3C-D, the device 100 is connected to and controlled through a computer 130.

In FIG. 3A, a data storage PC card 120A is inserted into the storage device 100. As indicated by the solid line, data can be transferred from the data storage card 120A to the storage module 204 of the storage device 100. As indicated by the dashed line, data can be transferred from the storage module 204 to the data storage card 120A.

In FIG. 3B, the data storage card 120 requires an adapter 122 in order to be inserted into the storage device 100. The solid and dashed lines indicate the flow of data between the data storage card 120 and the storage device 100 as it passes through the adapter 122.

In FIG. 3C, the data storage device 100 is connected to a PC 130. The device driver 131 and the storage device 100 are configured to make the mass data storage module 202 of the storage device 100 appear as an additional logical drive on the computer 130. Accordingly, files can be transferred from the storage module 202 to the computer 130, as indicated by the solid line, and from the computer 130 to the storage module 202 as indicated by the dashed line.

In FIG. 3D, the data storage card 120 is inserted in the storage device 100 and the storage device 100 is connected to the computer 130. In this case, the device driver 131 and the storage device 100 are configured to make the storage card 120 appear as still another logical drive on the computer 130. Accordingly, files can be transferred from the storage card 120 to the computer 130 through the storage device 100, as indicated by the solid line. Files can also be transferred from the computer 130 to the storage card 120, through the storage device 100, as indicated by the dashed line.

In FIG. 3E, in accordance with one embodiment of the invention, the data storage device 100 is connected to an audio device 310, such as a set of headphones or a set of powered speakers. The audio decoder module 270 decodes an audio file stored on the data storage module 204, and the audio output 272 preferably provides a headphone level audio signal through the audio output 272. Alternatively or additionally, the data storage device 1000 may be connected to a video device 320, such as a monitor or a video projector. In one aspect, the digital image decoder module 274 can decode an image file, such as one taken from a digital camera and stored on the data storage module 204. The image decoder module 274 preferably provides the digital image through the video output 276. In another aspect, the video decoder module 278 can decode a digital video sequence stored on the data storage module 204. The video decoder module 274 also preferably provides the sequence through the video output 276.

IV. Methods

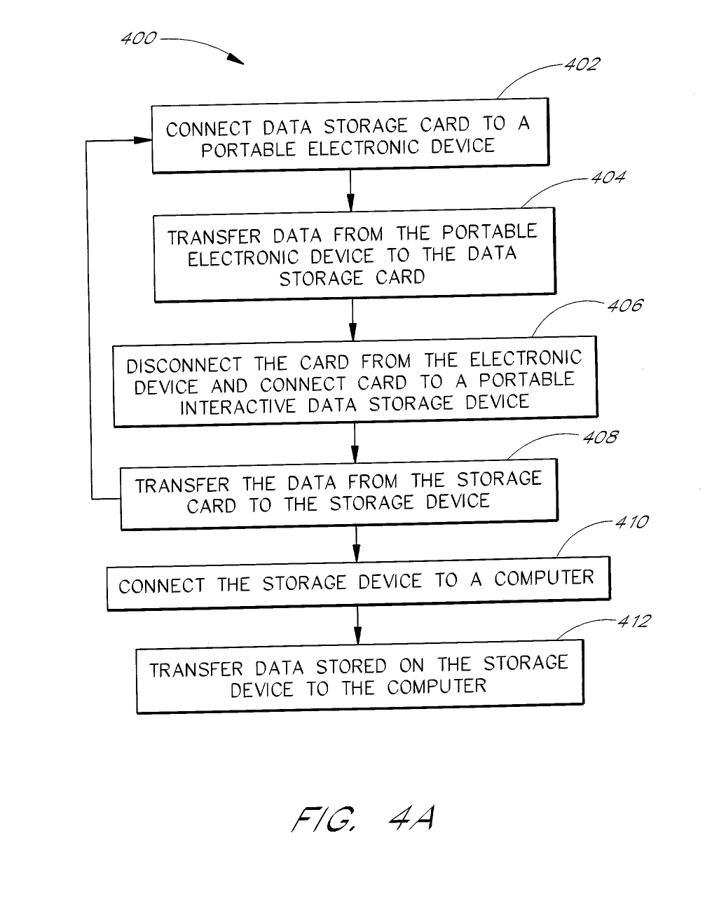

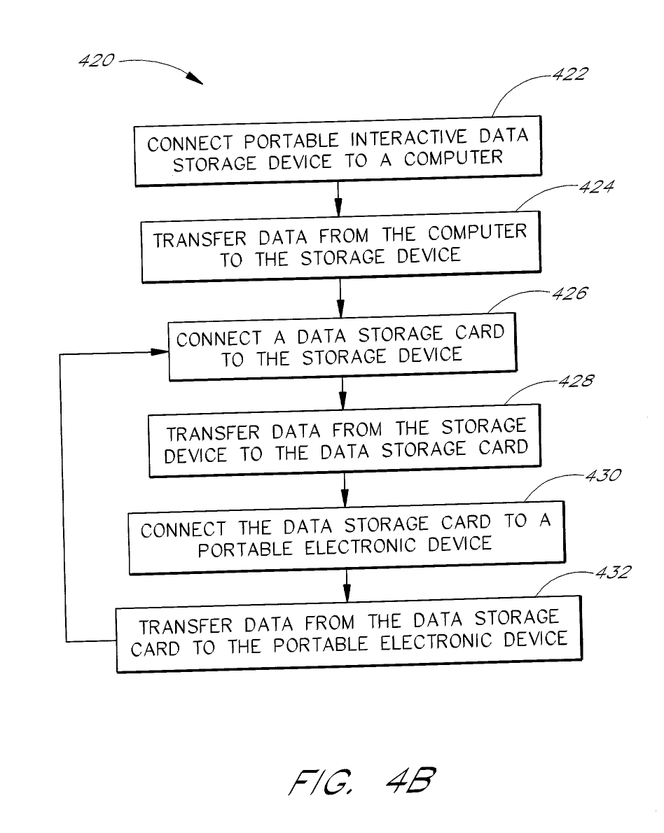

FIG. 4A illustrates a first process 400 that enables a user to reuse a data storage card 120, such as a CompactFlash card, to repeatedly capture newly created data without having to upload captured data to a computer 130 between uses. At a step 402, the user connects the data storage card 120 to a portable electronic device 116. For example, if the storage card 120 is a CompactFlash card and the device 116 is a digital camera, the user slides the card 120 into a receiving slot on the camera.

At a step 404, the user transfers data from the electronic device 116 onto the storage card 120. For example, the user may take a digital photograph with a digital camera. The digital photograph data, which is created by the camera, is then stored on the storage card 120.

At a step 406, the user disconnects the data storage card 120 from the portable electronic device 116 and connects it to the handheld portable electronic storage device 100. Depending upon the configuration of the storage card 120, the user may insert the storage card 120 directly into the storage device 100, or the user may insert the card 120 into an adapter 122 and then insert the adapter into the device 100.

At a step 408, the user transfers the data on the data storage card 120 to the storage device 100. The user preferably uses the display 104 and the user controls 106 to interactively upload the data from the storage card 120 onto the storage device 100. The storage card 120 can be cleared, or the data can be left on the card.

At this point, since the data on the storage card 120 has been stored on the storage device 100, the data card can again be loaded with new data. Accordingly, the user may choose to repeat the steps 402-408 a number of times. The number of times the steps 402-408 can be repeated is limited by the capacity of the mass data storage module 204 of the storage device 100 and the power of the batter pack 214. In the preferred embodiment, the mass data storage module 204 has a capacity of about 3.5 gigabytes. This data storage capacity would allow a 64 megabyte card to be uploaded about 54 times. In the preferred embodiment, the battery pack 214 operates the device 100 for at least 200 minutes and can be recharged with a portable charger.

At a step 410, after steps 402-408 have been repeated one or more times, the user connects the storage device 100 to the computer 130. The connection is preferably established through a USB cable 132 and is supported by a device driver 131 running on the computer 130. Alternatively, other connection technologies can be used, such as, for example, an infrared transmitter/receiver connection. The device driver 131 preferably allows the mass data storage module 204 and, if inserted, the data storage card 120 to be accessed as additional logical drives from the computer 130.

At a step 412, the user transfers some or all of the data stored on the device's mass data storage module 204 to the disk drive of the computer 130. The driver 131 preferably allows the user to use the standard file copying procedures of the computer 130 to transfer the data. In the case that the data includes digital images, the images can be displayed on the computer's monitor.

FIG. 4B illustrates a second process 420 for using the handheld portable electronic storage device 100 as a repository of data to be used in a portable electronic device 116. The process 420 may be performed, for example, to allow data stored on a computer 130 to be transferred onto a storage card 120, in small portions, for use in a portable electronic device 116, such as an MP3 player or a PDA.

At a step 422, the user connects the portable interactive data storage device 100 to a computer 130. At a step 424, the user transfers data from the computer 130 to the storage device 100. The data may be, for example, several digital audio files in MP3 format. An hour of music in MP3 format occupies approximately 64 megabyes. Accordingly, a 3.5 megabyte storage module 204 can hold approximately 54 hours of music. The data may alternatively be, for example, digital images that a user wishes to display on a personal digital assistant (PDA). Once the user has transferred data onto the storage device 100, the storage device 100 can be disconnected from the computer 130.

At a step 426, the user connects a data storage card 120 to the storage device 100. At this point, the user may be on vacation or at work, far away from his personal computer. At a step 428, the user transfers data from the storage device 100 to the data storage card 120. The user preferably uses the display 104 and the user controls 106 to interactively download data from the storage device 100 onto the storage card 120. The data transferred to the storage card 120 is preferably a small portion of the data transferred from the computer 130 to the storage device 100 in the step 424. For example, if the data storage card has a 64 megabyte capacity, the data transferred onto the storage card 120 may be about an hour's worth of MP3 music. The data transferred, may alternatively be, for example, several digital images that the user wishes to display on a PDA. Once the user has transferred the data onto the storage card 120, the storage card can be disconnected from the storage device 100.

At a step 430, the user connects the storage card 120 to a portable electronic device 116. The portable electronic device may be, for example, an MP3 player or a PDA. At a step 432, the user transfers the data on the storage card 120 to the portable electronic device 116. If the portable electronic device 116 is an MP3 player, for example, the player preferably reads MP3 data from the card 120, decodes it, and outputs an audio signal. If the portable electronic device 116 is a PDA, for example, the user may use the PDA to read image data from the storage card 120 and display the images on the screen of the PDA.

Once the user has used the data stored on the storage card 120, the user may repeat the steps 426-432 as many times as desired to access and use the data stored on the storage device 100. Accordingly, the process 420 allows a user to reuse a single data storage card 120 to access a substantially greater amount of data than the card's capacity without having to download data from a computer 130 between uses.

V. Conclusion

While certain exemplary preferred embodiments have been described and shown in the accompanying drawings, it is to be understood that such embodiments are merely illustrative of and not restrictive on the broad invention. Further, it is to be understood that this invention is not limited to the specific construction and arrangements shown and described since various modifications or changes may occur to those of ordinary skill in the art without departing from the spirit and scope of the invention as claimed. It is intended that the scope of the invention be limited not by this detailed description but by the claims appended hereto. In the claims, a portion shall include greater than none and up to the whole of a thing. In the method claims, reference characters are used for convenience of description only, and do not indicate a particular order for performing the method.

What is claimed is:

1. A method of transferring data between a portable electronic device and a computer, the method comprising:
(A) connecting a data storage card to the portable electronic device;
(B) subsequent to (A), transferring data between the data storage card and the portable electronic device;
(C) connecting the data storage card to a handheld portable interactive data storage device that does not comprise a keyboard;
(D) subsequent to (C), transferring the data that is transferred in (B) between the storage card and the handheld portable interactive data storage device;
(E) performing the combination of (A), (B), (C), and (D) a plurality of times during an interval when the handheld portable interactive data storage device is not connected to the computer;
(F) connecting the handheld portable interactive data storage device to the computer; and
(G) subsequent to (F), transferring the data that is transferred in (E) between the handheld portable interactive data storage device and the computer.

2. The method of claim 1, wherein the data transferred in (G) comprises at least one digital image.

3. The method of claim 1, wherein the portable electronic device is a digital camera.

4. The method of claim 3, wherein the data transferred in (G) is created by the digital camera.

5. The method of claim 1, wherein (E) is performed prior to (F).

6. The method of claim 1, wherein the data transferred in (B) is transferred from the portable electronic device to the data storage card.

7. The method of claim 6, wherein the data transferred in (D) is transferred from the storage card to the handheld portable interactive data storage device.

8. The method of claim 7, wherein the data transferred in (G) is transferred from the handheld portable interactive data storage device to the computer.

9. The method of claim 1, wherein (F) is performed prior to (E).

10. The method of claim 1, wherein the data transferred in (G) is transferred to the handheld portable interactive data storage device from the computer.

11. The method of claim 10, wherein the data transferred in (D) is transferred to the storage card from the handheld portable interactive data storage device.

12. The method of claim 11, wherein the data transferred in (B) is transferred to the portable electronic device from the data storage card.

13. The method of claim 1, wherein the handheld portable interactive data storage device comprises a mass data storage module;

14. The method of claim 13, wherein the mass data storage module has a capacity of at least one gigabyte.

15. The method of claim 13, wherein the mass data storage module is a hard disk drive.

16. The method of claim 13, wherein the handheld portable interactive data storage device further comprises a card socket configured to receive the data storage card.

17. The method of claim 16, wherein the card socket is a PC card socket.

18. The method of claim 16, wherein the card socket is a COMPACTFLASH socket.

19. The method of claim 16, wherein the handheld portable interactive data storage device further comprises a display.

20. A method of transferring data between a data storage card and a computer, the method comprising:
(A) providing a handheld portable interactive data storage device that does not comprise a keyboard;
(B) connecting the data storage card to the handheld portable interactive data storage device;
(C) subsequent to (B), transferring data between the data storage card and the handheld portable interactive data storage device;
(D) subsequent to (C), disconnecting the data storage card from the handheld portable interactive data storage device;
(E) performing the sequence of (B), (C), and (D) a plurality of times during an interval when the handheld portable interactive data storage device is not connected to the computer;
(F) connecting the handheld portable interactive data storage device to the computer; and
(G) subsequent to (F), transferring the data that is transferred in (E) between the handheld portable interactive data storage device and the computer.

21. The method of claim 20, wherein (E) is performed prior to (F).

22. The method of claim 20, wherein (F) is performed prior to (E).

23. A handheld portable interactive data storage device comprising:
a mass data storage module;
a card socket configured to receive a data storage card;
a communication module configured to support communication between the device and a computer;
a processor connected to the mass data storage module, the card socket, and the communication module; and
a palm-sized housing containing the mass data storage module, the card socket, the communication module, and the processor,
wherein the device does not comprise a keyboard.

24. The device of claim 23, wherein the mass data storage module has a capacity of at least one gigabyte.

25. The device of claim 23, wherein the mass data storage module is a hard disk drive.

26. The device of claim 23, wherein the card socket is a PC card socket.

27. The device of claim 23, wherein the card socket is a COMPACTFLASH socket.

28. The device of claim 23, further comprising a display.

29. The device of claim 28, wherein the display is touch sensitive.

30. The device of claim 28, further comprising a plurality of user controls.

31. The device of claim 23, wherein the communication module is a USB controller.

32. A system comprising:
a personal computer; and
a handheld portable interactive data storage device connected in communication with the personal computer, the handheld portable interactive data storage device comprising:
a mass data storage module,
a card socket receiving a data storage card;
a communication module configured to support communication between the device and the computer,
a processor connected to the mass data storage module, the card socket, and the communication module, and
a palm-sized housing containing the mass data storage module, the card socket, the communication module, and the processor,
wherein the handheld portable interactive data storage device does not comprise a keyboard, and wherein the computer and the handheld portable interactive data storage device are configured such that the mass data storage module is accessible through the computer as a first logical drive.

33. The system of claim 32, wherein the computer and the handheld portable interactive data storage device are configured such that the data storage card is accessible through the computer as a second logical drive.

34. The system of claim 32, wherein the mass data storage module has a capacity of at least one gigabyte.

35. The system of claim 32, wherein the mass data storage module is a hard disk drive.
